(19) United States
(12) Patent Application Publication
(10) Pub. No.: US 2010/0042997 A1
(43) Pub. Date: Feb. 18, 2010

(54) CONDITIONED SCALABLE NON-ZERO INDICATOR

(75) Inventors: Yosef Lev, Cambridge, MA (US); Marek K. Olszewski, Cambridge, MA (US)

Correspondence Address: PVF -- SUN MICROSYSTEMS INC.;C/O PARK, VAUGHAN & FLEMING LLP, 2820 FIFTH STREET, DAVIS, CA, 95618-7759, US

(73) Assignee: SUN MICROSYSTEMS, INC., Santa Clara, CA (US)

(21) Appl. No.: 12/200,206

(22) Filed: Aug. 28, 2008

Related U.S. Application Data
(60) Provisional application No. 61/089,813, filed on Aug. 18, 2008.

(51) Int. Cl. G06F 9/46

(52) U.S. Cl. 718/100

(57) ABSTRACT

Apparatus, methods, and computer-program products are disclosed for performing an Arrive operation on a concurrent hierarchical Scalable Non-Zero Indicator (SNZI) object wherein the concurrent hierarchical SNZI object is a conditioned-SNZI (CSNZI) object that includes a parent CSNZI node. The method invokes a parent Arrive operation on the parent CSNZI node and returns an arrive failure status if the CSNZI object is disabled.

### RELATED APPLICATIONS

This application claims the benefit under 35 U.S.C. §119(e) of U.S. Provisional Application No. 61/089,813, filed 18 Aug. 2008, entitled “Scalable Non-Zero Indicator”, with inventors Yosef Lev, and Marek K. Olszewski, and attorney docket number SUN09-0034PSP, which is hereby incorporated by reference in its entirety. In addition, U.S. patent application Ser. No. 11/939,372, filed 13 Nov. 2007, entitled “System and Method for Implementing Shared Scalable Nonzero Indicators,” having first-named inventor Mark S. Moir, is hereby incorporated by reference in its entirety.

### BACKGROUND

1. Technical Field

The disclosed technology relates to the field of concurrently accessed data structures used by computer systems.

2. Related Art

Counters that are shared by multiple computer processors (shared-counters) are useful for a variety of purposes, for example for implementing reader/writer locks that can be used to synchronize thread access to some shared memory area. However, there are no shared-counter implementations that have the following properties: non-blocking, linearizable, independent of number of threads, scalable, and fast in the absence of contention.

Full use of shared-counter semantics is not required for many applications. Often applications need only determine whether the shared-counter is zero or non-zero and need not determine the exact value of the shared-counter. A non-zero indicator has the semantics shown in Table 1. A non-zero indicator can be implemented using a shared-counter, where Arrive operations increment the shared-counter, Depart operations decrement the shared-counter, and Query operations simply return whether the shared-counter is non-zero. The surplus is the number of Arrive operations minus the number of Depart operations. If the number of Arrive operations equals the number of Depart operations, the surplus is zero. If the number of Arrive operations exceeds the number of Depart operations, the surplus is non-zero; by the well-formedness condition, the number of Depart operations cannot exceed the number of Arrive operations. Note that such a shared-counter implementation of a non-zero indicator maintains the exact difference between the number of Arrive operations and the number of Depart operations on the Scalable Non-Zero Indicator object, and thus provides stronger semantics than is required by the semantics for a non-zero indicator, which need only represent whether or not the number of Depart operations differs from the number of Arrive operations (whether the surplus is zero or non-zero). Also note that the shared-counter implementation of a non-zero indicator just described does not scale with the addition of threads on a multiprocessor computer (for example, a multi-core processor or multiprocessor server). On such computers, contention caused by multiple threads concurrently accessing the shared-counter can severely degrade performance.

TABLE 1
Non-zero Indicator Semantics

| | |
|---|---|
| Arrive: | Increment the surplus by 1. |
| Depart: | Decrement the surplus by 1. |
| Query: | Return true if and only if the surplus is non-zero. |
| Well-formedness: | The number of invoked Depart operations never |
| | exceeds the number of Arrive operations returned. |

U.S. patent application Ser. No. 11/939372 ('372) taught a Scalable Non-Zero Indicator (SNZI) that has the non-blocking, linearizable, independent of number of threads, scalable, and fast in the absence of contention properties. The SNZI object disclosed therein included Arrive, Depart, and Query operations. The Query operation returns whether or not there have been more Arrive operations than Depart operations (whether the surplus is non-zero).

In '372, the SNZI object has a hierarchical structure (such as a representative hierarchical SNZI data structure 100 of FIG. 1). The representative hierarchical SNZI data structure 100 has a shared-counter/indicator bit 101 controlled by, or contained within, a SNZI root node 103. The SNZI root node 103 is the parent SNZI node to some number of SNZI nodes such as a first level child node 105 that, in turn, can be the parent SNZI node to some number of lower-level SNZI nodes such as the second level child node 107, etc. Arrive or Depart operations can be invoked on any given SNZI node, and these operations can invoke corresponding operations on the given SNZI node's parent SNZI node (if one exists). If the additional indicator word is not used, the root node can be a simple non-scalable, non-zero indicator (such as one based on a shared-counter as previously described). If a single bit indicator in an indicator word is needed (to indicate whether the surplus is zero or not), the root node can be implemented using the special root node algorithm described in '372. This construction of a SNZI object allows the SNZI nodes to act as filters to reduce contention to the shared-counter/indicator bit 101 representing the surplus for the SNZI object because Arrive and Depart operations made on a given SNZI node only invoke the parent SNZI node's Arrive and Depart operations when the node's surplus may change from zero to non-zero and from non-zero to zero, respectively.

The Arrive and Depart operations applied to each SNZI node in the SNZI object complies with a “Well-Formedness” rule such that the total number of Depart operations invoked on a SNZI node never exceeds the number of Arrive operations that were invoked on that SNZI node and have already returned.

A SNZI node in the SNZI object can be implemented using its parent SNZI node. The Arrive and Depart operations maintain a SNZI Invariant. The SNZI Invariant is that a parent SNZI node has a surplus contribution from its child SNZI node (which means that the child SNZI node has executed more Arrive operations than Depart operations on the parent SNZI node) if and only if that child SNZI node has a non-zero surplus. Given the SNZI Invariant, Arrival (and the corresponding Departure) operations can take place at any SNZI node, and Query operations can be done directly on the root node (or on a shared-counter/indicator bit controlled by the root node), because the SNZI Invariant guarantees that if any SNZI node has a surplus, then so does the root node.

In this manner, a child SNZI node serves as a filter of Arrive and Depart operations for its parent SNZI node because the child SNZI node only propagates operations to the parent SNZI node that may change the surplus of the child SNZI node (the child SNZI node propagates its zero-to-non-zero transitions and non-zero-to-zero transitions). Therefore, the structure of the concurrent hierarchical SNZI object greatly reduces the contention on the root node. This allows the use of a non-scalable, non-zero indicator solution at the root node (for example, a simple shared-counter or indicator bit), without jeopardizing the scalability of the SNZI object.

A correct SNZI object implementation should handle a zero-to-non-zero transition of the SNZI node's surplus in a linearizable and non-blocking way while still maintaining the SNZI Invariant and acceptable performance. In the approach taken by '372, the zero-to-non-zero transition is handled by having a shared-counter in each SNZI node that is used to keep track of the SNZI node's surplus. Transitions of the shared-counter between “regular” non-zero values do not require invocation of the Arrive operation of the parent SNZI node. However, for a zero-to-non-zero transition of the shared-counter, a special intermediate value, ½, is assigned to the shared-counter until the required Arrive operation on the parent SNZI node completes. This ½ value indicates to other threads that a given thread is in the process of a zero-to-non-zero transition and so is in the process of arriving at the parent SNZI node. If a second thread should read the ½ value from the shared-counter, the second thread does not wait for the given thread to complete (because the given thread may no longer be scheduled, or perhaps, it may have aborted), and instead, the second thread attempts to “help” the given thread complete its Arrive operation so that the second thread can itself proceed. The second thread “helps” by invoking an Arrive operation on the parent SNZI node before incrementing the child SNZI node's counter.

The use of such an intermediate value requires two compare-and-swap operations (even with non-contended Arrive operations) and significantly complicates the SNZI object algorithms; for example, use of the intermediate value requires the addition of a version number to the counter to deal with an ABA problem (where an Arrive operation that changes the counter from 0 to ½ is delayed long enough for the counter to change and become ½ again). In addition, Arrive operations in '372 must complete because if the Arrive operation failed, it may leave the counter with the special intermediate ½ value, which would break one or more of the SNZI Invariants.

One application for a SNZI object is as a building block for a readers-writer lock (RWLock). A RWLock is a lock that can be acquired exclusively for write, or non-exclusively for read. That is, an acquisition for read succeeds if and only if the lock is not acquired for write, and an acquisition for write succeeds if and only if the lock is not acquired for write and the lock is not acquired for read. A SNZI object can then be used to keep track of whether any readers are holding the lock, for example by having a read acquisition invoke an Arrive operation, a read-release invoke a Depart operation, and having the indicator bit be integrated into the lock's word that keeps track of whether the lock is held, and in which mode.

However, the SNZI object of '372 does not allow an Arrive operation to fail if a writer is already holding the lock. That is, if a thread begins an Arrive operation that was not yet linearized (the time at which the operations seem to take effect), and a writer sees that there are no readers holding the lock and acquires the lock for write, then the reader's Arrive operation must fail—but Arrive operation failure is not supported by the SNZI object of '372.

The incorporated reference '372 introduced a resettable version of SNZI, called SNZI-R, which allows the SNZI object to be reset, disallowing Arrival operations that began before a reset operation from succeeding. However, the solution requires adding an additional “Epoch” field to the indicator word which uses up precious bits that are often needed for other uses. For example, since this Epoch field is maintained even while there are no readers holding the lock, the solution is not suitable for some RWLocks that need a large number of bits in the lock word to store the writer thread's thread ID, or a pointer to its process control block (if running in kernel space), when the lock is held by a writer. Furthermore, the SNZI-R semantics are stronger than those required by a RWLock, and so a SNZI-R implementation of a RWLock has additional overhead.

### BRIEF DESCRIPTION OF THE FIGURES

FIG. 1 illustrates a representative hierarchical SNZI data structure;

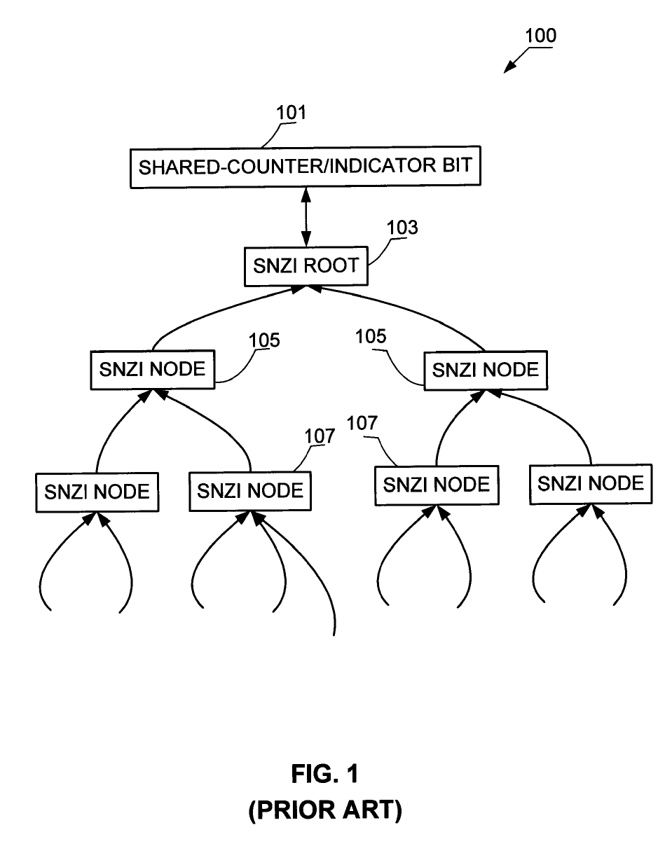

FIG. 2 illustrates a networked computer system having the capability to use the disclosed technology;

FIG. 3 illustrates a SNZI object Arrive process;

FIG. 4 illustrates a SNZI object Depart process; and

FIG. 5 illustrates a CSNZI object Arrive process.

### DETAILED DESCRIPTION

The technology disclosed herein teaches a computer-controlled method for performing An arrive operation on a concurrent hierarchical SNZI object wherein the concurrent hierarchical SNZI object is a conditioned-SNZI object (CSNZI object) that includes a parent CSNZI node. The method invokes a parent Arrive operation on the parent CSNZI node and returns an arrive failure status if the CSNZI object is disabled. Apparatus that perform the method, and program products that contain computer instructions that, when executed by the computer, cause the computer to perform the method are also disclosed.

The described technology teaches a new scalable non-zero indicator algorithm that is more efficient and simpler to understand than the scalable non-zero indicator algorithm disclosed in '372.

Data Structure—A data structure is an ordered arrangement of storage in memory for variables. A data structure is generally part of an Object-Oriented Programming (OOP) object.

Object—An object in the object-oriented programming paradigm is an association between programmed methods and the data structures defined by a class and the instantiated storage that represents an object of the class.

Pointer—A pointer is a data value that is used to reference a data structure or an object. One skilled in the art will understand that “pointer” includes, without limitation, a memory address to, or a value used to calculate the address to, the information of interest and any functional equivalents, including handles and similar constructs.

Programmed method—A programmed method is a programmed procedure associated with an object. The programmed method is invoked to cause the object to perform an operation. In the procedural programming paradigm, a programmed method is equivalent to a programmed routine or function.

Procedure—A procedure is a self-consistent sequence of steps that can be performed by logic implemented by a programmed computer, specialized electronics or other circuitry, or a combination thereof that leads to a desired result. These steps can be defined by one or more computer instructions. These steps can be performed by a computer executing the instructions that define the steps. Further, these steps can be performed by circuitry designed to perform the steps. Thus, the term “procedure” can refer (for example, but without limitation) to a sequence of instructions, a sequence of instructions organized within a programmed-procedure or programmed-function, a sequence of instructions organized within programmed-processes executing in one or more computers, or a sequence of steps performed by electronic or other circuitry, or any logic or combination of the foregoing. In particular, the methods and processes described herein can be implemented with logics such as (for example, but without limitation) a disable logic, an enable logic, an invocation logic, a return logic, a readers-writer lock logic, a writer lock acquisition logic, etc.

One skilled in the art will understand that although the following description of the technology is cast within an object-oriented programming paradigm, the techniques disclosed are applicable to other programming paradigms that are usable in a concurrent programming environment. Such a one will also understand that '372 teaches concurrent hierarchical SNZI objects such as SNZI, SNZI-R objects, etc., and that are implemented using different algorithms from those disclosed herein. In addition, such a one will understand that the increment and decrement operations in Table 1 are inverse operations to each other and that equivalent inverse operations could be used.

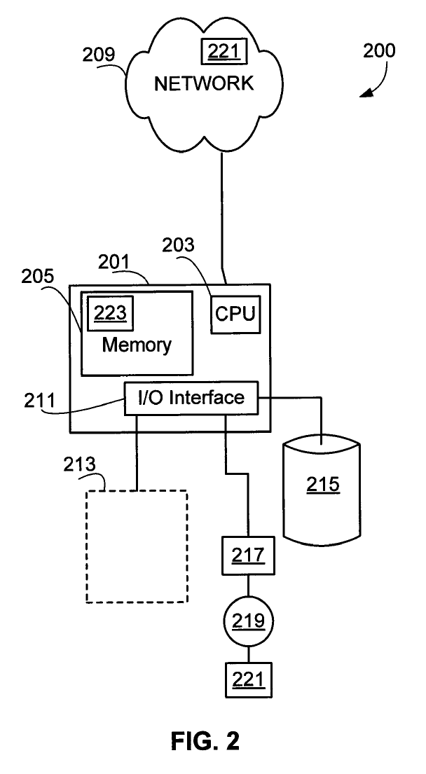

FIG. 2 illustrates a networked computer system 200 that can incorporate the technology described herein. The networked computer system 200 includes a computer 201 that incorporates a CPU 203 (processor unit), a memory 205 that can be accessed by each of the processors in the CPU 203, and a network interface (not shown). The network interface provides the computer 201 with access to a network 209. The memory 205 can be any technology that enables multiple processors to interleave read and write accesses to the memory. It is random access in the sense that any piece of data can be returned in constant time, regardless of the data's physical location and whether or not the returned data is related to the previous piece of data. Such memory can be core, SRAM, DRAM, EPROM, EEPROM, NOR flash, etc. The computer 201 also includes an I/O interface 211 that can be connected to an optional user interface device(s) 213, a storage system 215, and a removable data device 217. The removable data device 217 can read a computer-usable data carrier 219 (such as a fixed or replaceable ROM within the removable data device 217 itself (not shown)), as well as a computer-usable data carrier 219 that can be inserted into the removable data device 217 itself (such as a memory stick, CD, floppy, DVD or any other tangible media) that typically contains a program product 221. The user interface device(s) 213 can include a display device(s) and user input devices (not shown). The storage system 215 (along with the removable data device 217) and the computer-usable data carrier 219, and (in some cases including the network 209) comprise a file storage mechanism. The program product 221 on the computer-usable data carrier 219 can be read into the memory 205 or non-shared memory as a program 223 which instructs the CPU 203 to perform specified operations. In addition, the program product 221 can be provided from devices accessed using the network 209. One skilled in the art will understand that the network propagates information (such as data that defines a computer program). Signals can be propagated using electromagnetic signals, visible or invisible light pulses, signals on a data bus, or signals transmitted over any wire, wireless, or optical fiber technology that allows information to be propagated from one point to another. Programs and data are commonly read from both tangible physical media (such as those listed above) and from the network 209. Thus, the network 209, like tangible physical media, can be a computer-usable data carrier. One skilled in the art will understand that not all of the displayed features of the computer 201 need to be present for all embodiments that implement the techniques disclosed herein. In addition, such a one will understand that the technology disclosed herein will also apply to SMP systems where the processors are separate so long as the processors are in communication with, and share access to, the memory 205. Further, one skilled in the art will understand that the technology disclosed herein can also be used with a single CPU or single core CPU and non-shared memory, and that computers are ubiquitous within modern devices ranging from cell phones to vehicles to kitchen appliances, etc.

The networked computer system 200 is but one example where the technology disclosed herein can be used. Other examples include massive multiprocessor systems that can have processor-dedicated memory and at least one shared memory that is coupled between some or all of the processors in a massive multiprocessor system.

The inventors have arrived at the unexpected realization that the linearizability and non-blocking properties of a SNZI object do not require a change-of-state in a child SNZI node prior to invoking an Arrive operation on its parent SNZI node responsive to a zero-to-non-zero transition as is required by '372. As previously described, it is very difficult to allow an Arrive operation with the SNZI object of '372 to fail because of this change-of-state. Thus, it is believed that it is difficult to provide the enable-disable logic to the SNZI object of '372.

This realization enables the implementation of a SNZI object as is described herein. The inventors' realization leads to the deferral of the SNZI node's change-of-state until after arrival at the parent SNZI node. That is, an Arrive operation on the child SNZI node that observes its shared-counter as zero first invokes an Arrive operation on the parent SNZI node, and then attempts to (atomically) change the shared-counter in the child SNZI node from zero to non-zero. Patent application '372 teaches the use of threads to help other threads complete their parent Arrive operation. However, using the technology disclosed herein, threads can continue to help other threads complete their parent Arrive operation (to achieve the desired non-blocking behavior), but do so without knowing explicit signaling between the threads (as is accomplished by the ½ counter value used in '372) because the counter state is not changed until after a thread completes its parent Arrive. If, after invoking the Arrive operation on the parent SNZI node, the thread executing the Arrive operation on the child SNZI node was unable to perform the zero-to-non-zero transition on the child SNZI node's shared-counter (because a helping thread performed it first), that Arrive operation on the parent is considered superfluous (similar superfluous Arrive operations can occur using the SNZI object of '372). Such superfluous Arrive operations can be canceled by invoking corresponding Depart operations on the parent SNZI node. Because the change-of-state occurs after the invocation of the Arrive operation on the parent SNZI node, the state of the shared-counter in the child SNZI node does not indicate if the child SNZI node may be about to invoke an Arrive operation on the parent SNZI node. Thus, it is harder to implement contention mitigation strategies, such as delaying a thread before it performs a parent Arrive when another thread is performing such an Arrive. As a result, as described with respect to Table 7 and Table 8, an additional shared variable is introduced at each node to let threads announce to others their intention to Arrive at the parent node.

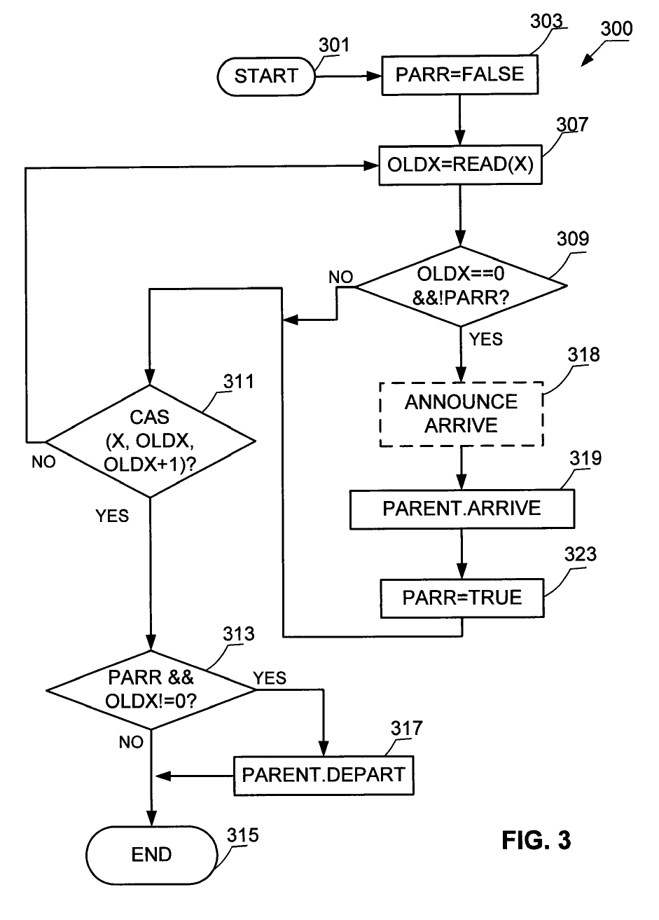

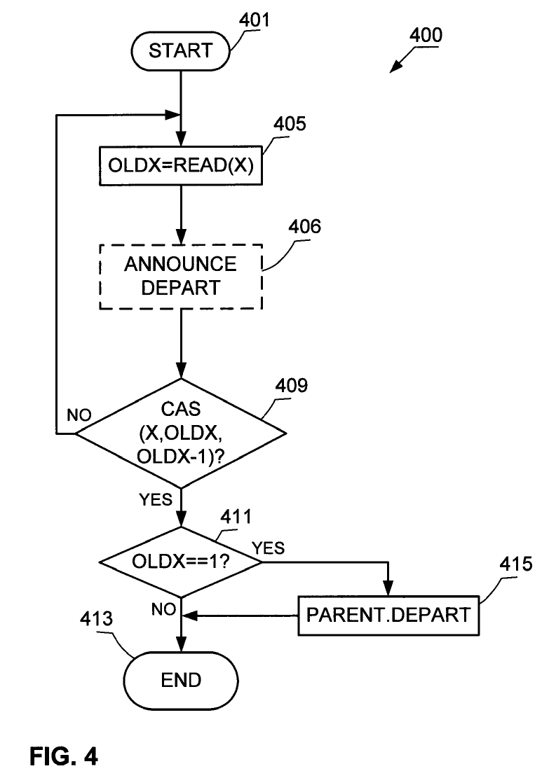

FIG. 3 illustrates a SNZI object arrive process 300 and FIG. 4 illustrates a SNZI object depart process 400, both of which represent the related portions of the pseudocode of Table 2. In the pseudocode of the subsequent tables, variables with initial capital letters are shared between threads, while variables with initial lowercase letters are thread local.

TABLE 2
SNZI Pseudocode

| | X : N //shared-counter, initially 0 |
|---|---|
| | Parent : Linearizable SNZI |
| Arrive | |
| | pArrInv <-- false |
| | repeat |
| 10 | oldx <-- Read(X) |
| | if oldx=0 && !pArrInv then |
| 11 | Parent.Arrive |
| | pArrInv <-- true |
| 12 | until CAS(X,oldx,oldx+1) |
| | if pArrInv && oldx!=0 |
| 13 | Parent.Depart |
| Depart | |
| | repeat |
| 14 | oldx <-- Read(X) |
| 15 | until CAS(X,oldx,oldx−1) |
| | if oldx = 1 |
| 16 | Parent.Depart( ) |

The SNZI object arrive process 300 initiates at a start terminal 301 when invoked by a child SNZI node or some program to register a use of the SNZI object. An ‘initialize parent arrive status’ procedure 303 sets the pArrInv local boolean to false. The pArrInv variable is used to indicate whether the thread executing the SNZI object arrive process 300 has invoked an Arrive operation on the parent SNZI node and is represented by “PARR” in the figures. Next a ‘read shared-counter’ procedure 307 reads the value of the shared-counter for this SNZI node into local oldx. Next, an ‘invoke arrive on parent’ decision procedure 309 determines whether a parent.arrive needs to be invoked. If oldx is not zero or pArrInv is true, a parent.arrive has already been invoked to indicate that this SNZI node has a surplus and no additional invocation of parent.arrive is needed. Note that if oldx is zero and pArrInv is true, then a parent.arrive has already been invoked.

If parent.arrive has already been invoked, the SNZI object arrive process 300 continues to an ‘atomic compare-and-swap’ decision procedure 311 that attempts to atomically increase the shared-counter for this SNZI node using a compare-and-swap (or equivalent atomic operation). In this embodiment, the shared-counter is increased by one. If the ‘atomic compare-and-swap’ decision procedure 311 was successful (meaning that X—the shared-counter—had the expected value of oldx at the time of the compare-and-swap), the SNZI object arrive process 300 continues to an ‘invoke depart on parent’ decision procedure 313 that determines whether this SNZI node's Arrive operation has invoked parent.arrive, and has not successfully changed the shared-counter from zero to non-zero afterwards. Note that an arrival at the parent SNZI node at line 11 is superfluous if it is not followed by a zero to non-zero transition of the shared-counter in the child SNZI node that invoked the Arrive operation on the parent SNZI node. The ‘invoke depart on parent’ decision procedure 313 determines whether the child SNZI node has invoked such a superfluous arrival. If such a superfluous arrival was invoked, a ‘parent depart’ procedure 317 cancels it by invoking a compensating Depart operation on the parent SNZI node. If pArrInv is false, or oldx is zero, the SNZI object arrive process 300 completes through the end terminal 315, since either there was no invocation of parent.arrive, or if there was such an invocation, it was not superfluous.

However, if the ‘invoke depart on parent’ decision procedure 313 determines that this thread has invoked parent.arrive, but oldx is not zero, then this thread's invocation of parent.arrive was superfluous and the SNZI object arrive process 300 continues to a ‘parent depart’ procedure 317 that invokes parent.depart to compensate for the superfluous Arrive operation.

Looking at the ‘atomic compare-and-swap’ decision procedure 311, if the compare-and-swap was not successful (because X had changed between the ‘read shared-counter’ procedure 307 and the ‘atomic compare-and-swap’ decision procedure 311), the SNZI object arrive process 300 continues back to the ‘read shared-counter’ procedure 307 to again attempt to alter X and to invoke parent.arrive if a zero-to-non-zero transition may occur and parent.arrive has not already been invoked.

Looking at the ‘invoke arrive on parent’ decision procedure 309, if oldx is zero and the Arrive operation on the child SNZI node has not yet invoked parent.arrive, the SNZI object arrive process 300 can continue to an ‘optional announce arrive’ procedure 318 (subsequently discussed with respect to Table 7 and Table 8) and then to a ‘parent arrive’ procedure 319 that propagates the zero-to-non-zero transition to the parent SNZI node by invoking parent.arrive, and a ‘set arrived at parent status’ procedure 323 changes the status of pArrInv to true to show that the thread executing the child SNZI node Arrive operation has invoked parent.arrive.

Note that there can be two or more threads that have concurrently invoked parent.arrive to propagate the zero-to-non-zero transition of the child SNZI node to the parent SNZI node and that the ‘parent arrive’ procedure 319 and the ‘set arrived at parent status’ procedure 323 can be executed by multiple threads (pArrInv is a local thread variable). Each of these threads can read X as zero, and invoke parent.arrive. The parent.arrive invocation at the parent SNZI node is superfluous if it is not followed by a successful transition of the shared-counter from zero to non-zero. Thus, while there may be a number of superfluous parent.arrive invocations, each superfluous invocation will be compensated for once the ‘atomic compare-and-swap’ decision procedure 311 succeeds.

Note that each Arrive operation invokes at most one Arrive operation on the parent SNZI node (as afterwards the local pArrInv variable has the value “true”); it can be proven that once an Arrive operation invokes an Arrive on the parent SNZI node, the parent SNZI node must have a surplus until that Arrive operation finishes, and hence there is no need to invoke an Arrive operation again even if the shared-counter in the child SNZI node is again seen to be zero.

The linearization points for the Arrive operation of this SNZI algorithm are at line 11 or successful execution of the compare-and-swap in line 12 of the pseudocode of Table 2, whichever is executed first. One skilled in the art will understand that a linearization point can be on a procedure call because the call is on an object that is linearizable.

FIG. 4 illustrates a SNZI object depart process 400 that can be invoked to remove a use of the SNZI object resulting from invocation of the SNZI object arrive process 300. The SNZI object depart process 400 initiates at a ‘start terminal’ procedure 401 and continues to a ‘read counter value’ procedure 405 that reads the current shared-counter value for the SNZI node. Once the current shared-counter value is captured in oldx, the SNZI object depart process 400 can continue to an ‘optional announce depart’ procedure 406 (subsequently described with respect to Table 7 and Table 8) and then to an ‘atomic compare-and-swap’ decision procedure 409 that executes an atomic compare-and-swap operation on the shared-counter to decrement the shared-counter and determine if it succeeded. If the ‘atomic compare-and-swap’ decision procedure 409 was successful, the SNZI object depart process 400 continues to a ‘parent depart’ decision procedure 411 that determines whether the shared-counter that was just reduced was equal to one. If the value just reduced was not equal to one, then a non-zero-to-zero transition has not occurred, and the SNZI object depart process 400 completes through the end terminal 413. However, if the value just reduced was equal to one, the SNZI object depart process 400 continues to a ‘parent depart’ procedure 415 that invokes parent.depart responsive to the non-zero-to-zero transition.

The linearization points for the SNZI object depart process 400 are at line 15, or a successful execution of the compare-and-swap at line 16 of the pseudocode of Table 2, whichever is executed last.

One skilled in the art, after reading the above disclosure and that of '372 will immediately notice the relative clarity of the new SNZI object algorithms disclosed herein. In addition, as will be subsequently described, the new SNZI object algorithms can be modified to indicate failure of the Arrive operation.

The incorporated reference '372 introduced a resettable version of SNZI, called SNZI-R, which allows the SNZI object to be reset, disallowing Arrival operations that began before a reset operation from succeeding (the semantics are the same as those defined in '372 and listed in Table 3). However, to do this SNZI-R adds an additional “Epoch” field (updated on every reset) to the indicator word, which uses up precious bits that are often needed for other uses.

TABLE 3
SNZI-R Semantics

| | |
|---|---|
| Arrive: | Increment the surplus by 1, return epoch. |
| Depart(e): | If e == epoch, decrement the surplus by 1. |
| Query: | Return epoch and true if and only if the surplus of |
| | epoch is non-zero. |
| Reset(e) | If e > epoch, then reset epoch to e and return true, |
| | else return false. |
| Well formedness: | The number of invoked depart(e) operations never |
| | exceeds the number of arrive operations that returned |
| | e. |

Even though the new SNZI object algorithms can be modified to indicate failing Arrive operations, it is still useful to apply the new SNZI object algorithms to a resettable concurrent SNZI object to achieve a more efficient SNZI-R implementation.

The pseudocode of Table 4 illustrates a new implementation of the resettable concurrent SNZI object. The arrive operation with the semantics of Table 3 will use the Query operation to obtain the current epoch, will use the epoch so obtained to perform the Arrive operation of Table 4, and then return that epoch. As in '372, Arrive and Depart operations pertain to a particular epoch, and the Query operation determines whether the number of Arrive operations exceeds the number of Depart operations for the current epoch and returns the current epoch. The Reset operation causes a transition to a new specified epoch, provided that this epoch is larger than the current epoch. In the implementation illustrated in Table 4 (for simplicity of presentation) epochs are assumed to be totally ordered. The SNZI-R pseudocode of Table 4 is similar to the SNZI pseudocode of Table 2, but has an associated Epoch field to hold a shared epoch value. A SNZI-R node has an epoch stored together with the node's shared-counter. If a node contains an epoch other than the current epoch, it is logically equivalent to containing the current epoch with the counter being zero. Therefore, steps of operations for an epoch e that encounter a node with an earlier epoch can simply update the node as if it contained epoch e and counter zero. If such a step is itself for an epoch before the current one, such a modification has no effect as the node still logically contains the current epoch and a shared-counter value of zero after the modification.

While the previous SNZI-R description and Table 4 describe an implementation that requires the epochs to be totally ordered, one skilled in the art will understand that other implementations can use unordered epochs. In such implementations, Reset is used to end one epoch and begin the next, and the programmed-method that invokes the Reset operation provides a “fresh” epoch value that has not been previously used.

One difference between an Arrive operation for such an embodiment and the one presented in Table 4 is with respect to the line marked by “#”. When used with unordered epochs, the Arrive operation does not check whether the operation's epoch e is newer than the node's epoch (that was read into oldx.e). Instead, when an Arrive operation notices that the operation's epoch e differs from the node's epoch, it checks whether the operation's epoch e is the current epoch (recall that the current epoch can be obtained by calling Query on the root node), and if so, proceeds with replacing the node's shared-counter word with the value 1 and the epoch e. One skilled in the art will understand that if e is tested and seen to be the current epoch, the old node's epoch could not be the current epoch when it is replaced with e (as it differs from e and because epochs are never re-used). Therefore, replacing the node's epoch with e is safe, even if e is no longer current when the successful compare-and-swap operation at line 12 (that does the replacement) takes place.

TABLE 4
SNZI-R Pseudocode

| | X=(c,e):(N,N) // counter, epoch Initially 0 |
|---|---|
| | Parent : Linearizable SNZI-R |
| Arrive(e) | |
| | pArrInv <-- false |
| | repeat |
| 10 | oldx <-- Read(X) |
| | if oldx.e>e then |
| | return |
| # | if oldx.c=0\|\|oldx.e<e then |
| | oldx’ <-- (1,e) |
| | if !pArrInv then |
| 11 | Parent.Arrive(e) |
| | pArrInv <-- true |
| | else |
| | oldx’ <-- (oldx.c+1,e) |
| 12 | until CAS(X, oldx, oldx’) |
| | if pArrInv && oldx’ .c!=1 |
| 13 | Parent.Depart(e) |
| Depart(e) | |
| | repeat |
| 14 | oldx <-- Read(X) |
| | if oldx.e != e then |
| | return |
| 15 | until CAS(X,oldx,(oldx.c−1,e)) |
| | if oldx.c = 1 |
| 16 | Parent.Depart(e) |

One skilled in the art will understand that the algorithms of Table 2 and Table 4 do not use a version number field as needed by the algorithms of '372. Removing the version field simplifies the algorithm and allows the algorithm to be applicable to systems that provide compare-and-swap operations on 32-bit words only because removal of the version field eliminates the ABA problem that can result from overflowing the version number field.

Note that because no shared memory variables were modified prior to arriving at the parent SNZI node, the SNZI object implementation shown in Table 2 and illustrated in FIG. 3 and FIG. 4 (and the implementation of Table 4) does not have the limitation of the SNZI object as implemented in '372 that prohibits Arrive operations from failing. Thus, if an Arrive operation on the parent SNZI node fails, the Arrive operation on the child SNZI node could return false without the need to clean up any modifications it has done to the shared state prior to the arrival at the parent SNZI node.

The new SNZI object algorithms, which can support Arrive operations that can fail (as subsequently described) can be used as a building block for RWLocks. By doing so, there is no need to use the additional “Epoch” field as used by SNZI-R. Instead, a Conditioned-SNZI object (CSNZI object) can be disabled if its surplus is zero. An Arrive operation will fail if the CSNZI object is disabled. The CSNZI object can be re-enabled such that subsequent Arrive operations can succeed.

TABLE 5
CSNZI Semantics

| | |
|---|---|
| Arrive: | If the CSNZI object is enabled, increment the surplus |
| | by 1 and return true. Otherwise leave the surplus as is |
| | and return false. |
| Depart: | Decrement the surplus by 1. |
| Query: | Return true if and only if the surplus is non-zero. |
| Disable: | If the CSNZI object is disabled, return false. |
| | If the CSNZI object is enabled and the surplus is zero, |
| | disable the CSNZI object and return true. Otherwise |
| | leave the CSNZI object enabled and return false. |
| Enable: | Enable a disabled CSNZI object. |
| Well-formedness: | The number of invoked depart operations never |
| | exceeds the number of returned arrive operations that |
| | returned true. |

One aspect of the technology described herein teaches a CSNZI object having the semantics shown in Table 5. In particular, the CSNZI object is a concurrent hierarchical SNZI object that includes Enable and Disable semantics.

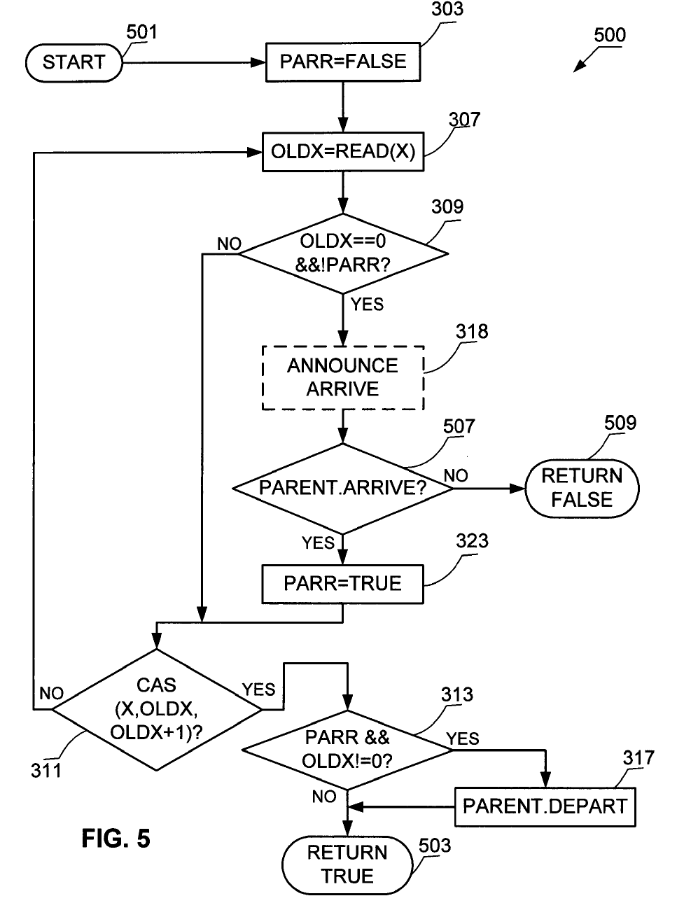

FIG. 5 illustrates a CSNZI object arrive process 500 which represents the related portions of the pseudocode of Table 6. The Depart operation on a CSNZI node is the same as that described with respect to FIG. 4.

TABLE 6
CSNZI Pseudocode

| | X : N //shared-counter, initially 0 |
|---|---|
| | Parent : Linearizable CSNZI |
| Arrive | |
| | pArrInv <-- false |
| | repeat |
| 10 | oldx <-- Read(X) |
| | if oldx =0 && !pArrInv then |
| 11 | if Parent.Arrive then |
| | pArrInv <-- true |
| | else |
| | return false |
| 12 | until CAS(X, oldx, oldx +1) |
| | if pArrInv && oldx!=0 |
| 13 | Parent.Depart |
| | return true |
| Depart | |
| | repeat |
| 14 | oldx <-- Read(X) |
| 15 | until CAS(X,oldx,oldx−1) |
| | if oldx = 1 |
| 16 | Parent.Depart( ) |

The CSNZI object operations can use many of the same procedures as are used in the SNZI object previously described with respect to FIG. 3. These procedures are identified by the same labels and are not further discussed with respect to the CSNZI object. As previously described, the SNZI object of Table 2 can be modified to support an Arrive operation that can fail.

A CSNZI object arrive process 500 initiates at a start terminal 501 and successfully completes through a ‘return true’ terminal 503 to return an arrive success status. If the ‘invoke arrive on parent’ decision procedure 309 is satisfied, the CSNZI object arrive process 500 can continue to the ‘optional announce arrive’ procedure 318 (subsequently described with respect to Table 7 and Table 8) and then to a ‘parent arrive’ decision procedure 507 that invokes the CSNZI object arrive process 500 on the parent CSNZI node. If the CSNZI object arrive process 500 on the parent CSNZI node returns true, the CSNZI object arrive process 500 continues to the ‘set arrived at parent status’ procedure 323 to continue the Arrive operation as previously described with respect to FIG. 3. However, if the ‘parent arrive’ decision procedure 507 returns false, the CSNZI object arrive process 500 continues to a ‘return false’ terminal 509 to return an arrive failure status that the Arrive operation on this CSNZI node failed.

The linearization points for the CSNZI object are: 1) a successful Arrive operation (one that returns true) is linearized at its successful increment of X at Line 12, or at its successful parent.Arrive at Line 11, whichever occurs first; 2) a failed Arrive operation is linearized at the failed parent.Arrive operation at line 11; and 3) the Depart operation is linearized at its last operation (either a successful decrement of X at line 15 or a parent.Depart operation at line 16).

Note that in the above algorithm, an Arrive operation only returns false (the arrive failure status) if the parent CSNZI node's Arrive operation returns false. Since the algorithm maintains the SNZI Invariant, it can be proven that the algorithm also maintains an Arrive Failure Invariant wherein an Arrive operation on the CSNZI node never fails if the CSNZI node has a surplus. The root node for the CSNZI object can maintain a boolean indicator as to whether the CSNZI object is enabled or disabled (for example, resulting from Enable or Disable operations performed on the CSNZI object). When the root node receives an Arrive operation, it can test whether the CSNZI object is disabled, and if so return false (the arrive failure status) that can be propagated down to the CSNZI node that received the Arrive operation. For example, in an embodiment where the root node implementation uses a simple counter, a flag (for example, a bit) can be added to the counter to indicate whether the CSNZI object is enabled or disabled. That flag can be manipulated atomically with the counter. An Arrive operation in such an embodiment atomically checks the flag and increments the counter if and only if the flag indicates that the CSNZI object is enabled. Similarly, a Disable operation atomically checks the counter and sets the flag to indicate that the CSZNI object is disabled if and only if the counter is zero (recall that when the root node is implemented with a simple counter, the counter value is the root node's surplus, which by the SNZI invariant, is zero if and only if all nodes have a zero surplus).

A RWLock implementation that uses a CSNZI object could be implemented to have a shared-counter-based RWLock implementation at the root of the CSNZI object such that an Arrive operation on the root node attempts to acquire the lock for read, returns true if successful, or false if the lock is held by a writer. (In this example, the Disable operation is used to acquire the lock for writing (it atomically checks that there are no readers and acquires the lock for write), and the Enable operation is used as the write-unlock operation.) Thus, a CSNZI object can be used in a wide range of RWLock implementations. Writers simply disable a CSNZI object whenever the writer acquires the RWLock. The Disable operation fails if the surplus is non-zero because a writer cannot acquire a RWLock while any reader holds the RWLock.

Note that for RWLock implementations that provide a reader-drain functionality (one where a writer can set a drain-bit to disallow any new readers from acquiring the lock—and hence causes the lock to be “drained” of readers), one skilled in the art will understand how to wrap the CSNZI object's Arrive method with an external wrapper that checks the drain-bit prior to calling the CSNZI object's Arrive operation to provide the desired functionality.

We turn now to discussion of the ‘optional announce arrive’ procedure 318 and the ‘optional announce depart’ procedure 406. While contention on the parent SNZI nodes has been primarily reduced by the filtering aspect of the child SNZI nodes, contention on the parent SNZI node can be further reduced by reducing superfluous Arrival operations on the parent SNZI node.

The previously described SNZI object implementations can be made more efficient by including an announce enhancement. The announce enhancement provides a small delay before Arrive operations on the child SNZI node invoke Arrive operations on the parent SNZI node, if the child SNZI node detects that another Arrive operation on the parent SNZI node may be in progress. The announce enhancement does not require any additional compare-and-swap operations. Furthermore, the rest of the SNZI object algorithm does not change: an Arrive operation executes exactly as before, except that small delays may be introduced. Therefore, all the aforementioned invariants of the algorithm still hold.

The announce enhancement adds a shared boolean flag (denoted as “Announce”) to the SNZI node. Announce is set before a thread arrives at the parent SNZI node and is reset by the last thread to depart the SNZI node. Therefore, if Announce is set and SNZI node's shared-counter is zero, then another thread is likely to be in the process of arriving at the parent SNZI node (or has already finished arriving at the parent SNZI node and may have even already incremented the shared-counter). Thus, if Announce is set, the thread can initiate a short delay (for example, by yielding its time slice or spinning in a loop). If, while waiting, the other thread completes its Arrival operation (which can be observed by seeing that the SNZI node's shared-counter has become non-zero), the thread restarts its Arrive operation. Restarting the Arrive operation in this manner has the same effect as if the thread were delayed right when it started arriving. This enhancement reduces contention on the parent because the restarted arrive operation will most likely observe a non-zero shared-counter in SNZI node and, therefore, will not attempt an Arrive operation on the parent.

However, if the shared-counter does not timely change, the thread continues after the delay to invoke an Arrive operation on the parent. In this way, the extension's only visible effects are added delays to the original algorithm and, therefore, it does not affect the algorithm's correctness.

The pseudocode of Table 7 and Table 8 teaches a CSNZI object embodiment with the announce enhancement. The added code is marked with asterisks and corresponds to the ‘optional announce arrive’ procedure 318 and the ‘optional announce depart’ procedure 406.

TABLE 7
CSNZI Arrive Pseudocode with Improved Contention Handling

| | |
|---|---|
| | X : N //shared-counter, initially 0 |
| * | Announce: Boolean // Initially false |
| | Parent : Linearizable CSNZI |
| Arrive | |
| | pArrInv <-- false |
| | repeat |
| 10 | oldx <-- Read(X) |
| | if oldx =0 && !pArrInv then |
| *11 | if Read(Announce) then |
| * | i <-- 0 |
| * | repeat until i>DelayAmount |
| *12 | if Read(X) !=0 then |
| * | goto 10 |
| * | i <-- i + 1 |
| *13 | Write(Announce, true) |
| 14 | if Parent.Arrive then |
| | pArrInv <-- true |
| | else |
| *15 | Write(Announce,false) |
| | return false |
| 16 | until CAS(X, oldx, oldx +1) |
| | if pArrInv && oldx!=0 |
| 17 | Parent.Depart |
| | return true |

TABLE 8
CSNZI Depart Pseudocode with Improved Contention Handling

| Depart | |
|---|---|
| | repeat |
| 18 | oldx <-- Read(X) |
| * | if oldx=1 then |
| *19 | Write(Announce, false) |
| 20 | until CAS(X,oldx,oldx−1) |
| | if oldx = 1 |
| 21 | Parent.Depart( ) |

One skilled in the art would understand how to implement the announce enhancement on SNZI and SNZI-R from the figures and the tables without undue experimentation. Such a one would also understand the linearization points for the pseudocode of Table 7 and Table 8 based on the previously described linearization points and the related descriptions.

One skilled in the art will understand that the technology disclosed herein teaches a CSNZI object, and new algorithms for implementing a SNZI object and a SNZI-R object, as well as how to use a CSNZI object, to implement a readers-writer lock.

From the foregoing, it will be appreciated that the technology has (without limitation) the following advantages:
1) The disclosed technology is more efficient because it uses a fewer number of compare-and-swap operations: In '372 under the un-contended case, the first arrival at each SNZI node (that is, an arrival when the SNZI object's surplus is zero) requires invoking two compare-and-swap operations on a counter residing in that SNZI node, and invoking an Arrive operation on the parent SNZI node of that SNZI node. As a result, every first arrival at the SNZI object requires 2*D compare-and-swap operations, where D is the number of SNZI nodes on the path from the SNZI node on which the Arrive operation is invoked to the root node. With the technology described herein, the number of compare-and-swap operations for a first arrival is a single compare-and-swap at each SNZI node on the path. Thus the disclosed technology is more efficient than that disclosed in '372.
2) The disclosed technology is significantly simpler than that taught in '372, because the disclosed technology need not handle the condition where one compare-and-swap operation succeeds while the other compare-and-swap operation does not (due to contention), as does '372.
3) The disclosed technology removes the need in '372 for using version numbers in the SNZI node's counter to avoid an ABA situation. Removing the version number eliminates the complexities resulting from the need to handle overflowing version number fields and enables the use of compare-and-swap operations on 32-bit words.
4) The disclosed technology supports extended SNZI object semantics that enable the SNZI object to be disabled or enabled (CSNZI object). These extended semantics allow the CSNZI object to be used as a building block for scalable readers-writer locks (unlike the SNZI object disclosed in '372 and without the need for an “Epoch” field as in the SNZI-R object disclosed in '372). Note, that the disclosed technology also teaches a more efficient SNZI-R object than that disclosed in '372.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art, which are also intended to be encompassed by the following claims. Unless specifically recited in a claim, steps or components of claims should not be implied or imported from the specification or any other claims as to any particular order, number, position, size, shape, angle, color, or material.

What is claimed follows:

1. A computer-controlled method for performing an arrive operation on a concurrent hierarchical Scalable Non-Zero Indicator (SNZI) object, said method comprising:
invoking a first parent arrive operation on a parent conditioned-SNZI (CSNZI) node wherein said concurrent hierarchical SNZI object is a CSNZI object comprising said parent CSNZI node; and
returning an arrive failure status if said CSNZI object is disabled.

2. The computer-controlled method of claim 1, further comprising disabling said CSNZI object.

3. The computer-controlled method of claim 2, wherein said CSNZI object is incorporated by a readers-writer lock and disabling is responsive to acquiring said readers-writer lock by a writer.

4. The computer-controlled method of claim 2, further comprising invoking a disable operation on said CSNZI object, wherein disabling is responsive to whether said CSNZI object has a zero surplus.

5. The computer-controlled method of claim 1, further comprising enabling said CSNZI object.

6. The computer-controlled method of claim 5, further comprising:
invoking a second parent arrive operation on said parent CSNZI node; and
returning an arrive success status if said CSNZI object is enabled.

7. The computer-controlled method of claim 1, wherein said parent CSNZI node further comprises a depart operation, said method further comprising invoking said depart operation.

8. An apparatus having a processing unit and a memory coupled to said processing unit for performing an arrive operation on a concurrent hierarchical SNZI object in said memory, said apparatus comprising:
an invocation logic configured to invoke a parent arrive operation on a parent CSNZI node wherein said concurrent hierarchical SNZI object is a conditioned-SNZI object (CSNZI object) comprising said parent CSNZI node; and
a return logic, responsive to the invocation logic, configured to return an arrive failure status if said CSNZI object is disabled.

9. The apparatus of claim 8, further comprising a disable logic configured to disable said CSNZI object.

10. The apparatus of claim 9, wherein the invocation logic is responsive to a readers-writer lock logic, said readers-writer lock logic comprising a writer lock acquisition logic, and wherein the disable logic is responsive to said writer lock acquisition logic.

11. The apparatus of claim 8, further comprising an enable logic configured to enable said CSNZI object.

12. The apparatus of claim 11, wherein the return logic is configured to return an arrive success status if said CSNZI object is enabled.

13. The apparatus of claim 8, wherein said parent CSNZI node further comprises a parent depart operation and the invocation logic is further configured to invoke said parent depart operation.

14. A computer program product for performing an arrive operation on a concurrent hierarchical SNZI object, the product comprising:
a computer-usable data carrier providing instructions that, when executed by a computer, cause said computer to perform a method comprising:
invoking a first parent arrive operation on a parent CSNZI node wherein said concurrent hierarchical SNZI object is a conditioned-SNZI object (CSNZI object) comprising said parent CSNZI node; and
returning an arrive failure status if said CSNZI object is disabled.

15. The computer-program product of claim 14, further comprising disabling said CSNZI object.

16. The computer-program product of claim 15, wherein said CSNZI object is incorporated by a readers-writer lock and disabling is responsive to acquiring said readers-writer lock by a writer.

17. The computer-program product of claim 15, further comprising invoking a disable operation on said CSNZI object, wherein disabling is responsive to whether said CSNZI object has a zero surplus.

18. The computer-program product of claim 14, further comprising enabling said CSNZI object.

19. The computer-program product of claim 18, further comprising:
invoking a second parent arrive operation on said parent CSNZI node; and
returning an arrive success status if said CSNZI object is enabled.

20. The computer-program product of claim 14, wherein said parent CSNZI node further comprises a parent depart operation, said method further comprising invoking said parent depart operation.
